(19) United States
(12) Patent Application Publication
(10) Pub. No.: US 2006/0191755 A1
(43) Pub. Date: Aug. 31, 2006

(54) Hydraulic vibration damper with non-buckling rebound buffer spring

(76) Inventors: Michael Fritz, Breckerfeld (DE); Uwe Klein, Wuppertal (DE)

Correspondence Address: Dr. Max Fogiel, 44 Maple Court, Highland Park, NJ, 08904, US

(21) Appl. No.: 11/353,712

(22) Filed: Feb. 14, 2006

(30) Foreign Application Priority Data
Feb. 25, 2005 (DE) 102005009213.6-12

(51) Int. Cl. F16F 9/12

(52) U.S. Cl. 188/266

(57) ABSTRACT

The invention relates to a hydraulic vibration damper with a cylindrical pipe (1), which is closed off by a sealing and guiding unit (6) and into which a piston rod (3), carrying a damper piston (2), which is passed through the sealing and guiding unit, can dip in an oscillating manner, the damper piston (2) dividing the interior space of the cylindrical pipe into an annular space (4) on the piston rod side and a working space (5) remote from the piston rod and a rebound buffer spring (7), constructed as a helical spring, which has a first end region (7a), facing the damper piston and a second end region (7b), facing the sealing and guiding unit (6), as well as a transition region (7c) connecting these to end regions, being disposed in the annular space (4) between the damper piston (2) and the sealing and guiding unit (6), characterized in that, within the transition region, the rebound buffer spring (7) has a section (7d), which extends in the axial direction over at least one helical spring coil and in which the internal diameter of the helical spring coils is smaller than the internal diameters of all other helical spring coils in the transition region (7c).

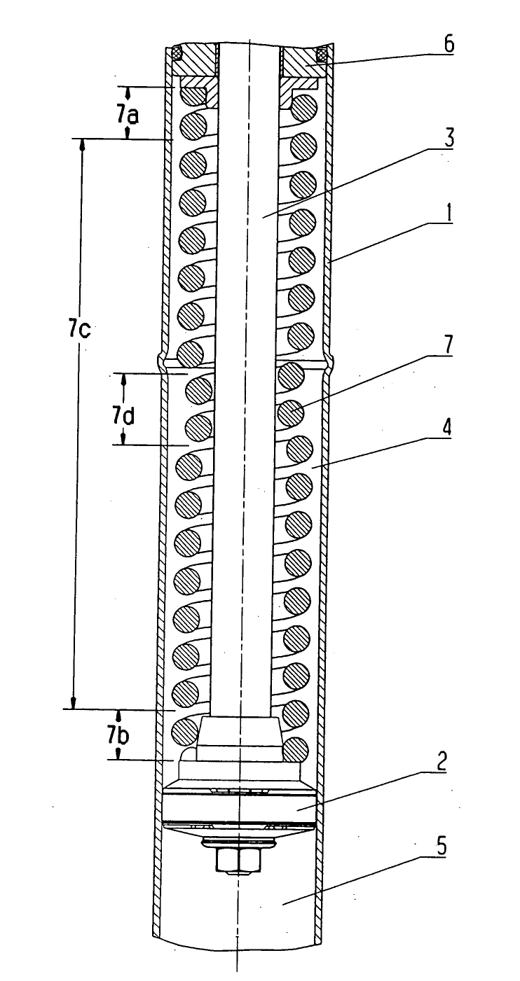

The invention relates to a hydraulic vibration damper with a cylindrical pipe, which is closed off by a sealing and guiding unit and into which a piston rod, carrying a damper piston, which is passed through the sealing and guiding unit, can dip in an oscillating manner, the damper piston dividing the interior space of the cylindrical pipe into an annular space on the piston rod side and a working space remote from the piston rod and a rebound buffer spring, constructed as a helical spring, which has a first end region, facing the damper piston and a second end region, facing the sealing and guiding unit, as well as a transition region connecting these to end regions, being disposed in the annular space between the damper piston and the sealing and guiding unit.

Such a vibration damper is known, for example, from the DE 44 20 134 C1. It is a disadvantage of this known vibration damper that, when a particular load is reached, the rebound buffer spring buckles towards the outside, that is, towards the inner wall of the cylindrical pipe, especially if, for structural reasons, large spring paths must be provided. If the path of the spring, which must be made available, exceeds a certain critical length, the rebound buffer spring may, under certain circumstances, no longer be designed so that it does not buckle. As a consequence, the rebound buffer spring buckles in the direction of the inner wall of the cylindrical pipe, coming into contact with it when the load exceeds the buckling load. There may be chip removal and damage to the wall of the cylinder and/or the rebound buffer spring. The grinding of the rebound buffer spring at the inner wall of the pipe, resulting from the buckling of the rebound buffer spring, causes chips to be detached from the pipe. This can affect the function of the damper negatively.

It is an object of the invention to make available a hydraulic vibration damper of the type named above, for which buckling of the rebound buffer spring in the direction of the inner wall of the cylindrical pipe is avoided reliably.

For a hydraulic vibration damper of the introductory portion of claim 1, this objective is accomplished owing to the fact that the rebound buffer spring has, within the transition region, at least a section, which extends in the axial direction over at least one helical spring coil and in which the internal diameter of the helical spring coils is smaller than the internal diameters of all other helical spring coils in the transition region.

Owing to the fact that, in the case of the invention, a section is present within the transition region, in which the internal diameter of the helical spring coils is smaller than the internal diameter of all other helical spring coils in the transition region, it is ensured that the rebound buffer spring, during the deflection and when a certain load is exceeded, does not buckle towards the outside in the direction of the inner wall of the cylindrical pipe. Instead, the rebound buffer spring buckles in the direction of the piston rod, so that the rebound buffer spring, when it buckles, contacts the piston rod. At the same time, the piston rod acts as a radial guide for the rebound buffer spring. Because of the hard surface of the piston rod, no material is removed (no chip formation) by the contact between the rebound buffer spring and the surface of the piston rod. Accordingly, the damper is spared from the negative effects of the chips that have been removed.

In the following, the invention is explained in greater detail by means of a drawing representing an example. The single Figure shows a vibration damper with a cylindrical pipe 1, which is closed off by a sealing and guiding unit 6. The piston rod 3 is passed through a central opening in the sealing and guiding unit 6, so that the piston rod 3 is passed through the sealing and guiding unit 6 and can rotate in an oscillating manner.

At the end of the piston rod 3, opposite the sealing and guiding unit 6, a damper piston 2 is disposed, which divides the interior space of the cylindrical pipe into an annular space 4 on the piston rod side and a working space 5, which is remote from the piston rod. In the annular space 4, a rebound buffer spring 7 is provided, which is constructed as a helical spring. The rebound buffer spring 7 has a first end region 7a, which is assigned to the sealing and guiding unit 6. Likewise, the rebound buffer spring 7 has a second end region 7b, which is assigned to the damper piston 2. A transition region 7c extends between the two end regions 7a, 7b.

The Figure shows the position of the damper piston, in which the latter has come into contact with the rebound buffer spring, that is, in which the rebound buffer spring has fulfilled its function as a rebound buffer.

Within the transition region 7c, there is a section 7d, in which precisely two helical spring coils have a clearly smaller internal diameter than all the remaining helical spring coils in the transition region 7c. Namely, in the example shown, all helical spring coils, which are within the transition region 7c but outside of section 7d, have a constant unchanging internal diameter, which is clearly larger than the external diameter of the piston rod 3. Only in section 7d is the internal diameter of the helical spring coils reduced. In the example shown, the internal diameters of the helical spring coils in section 7d are of such dimensions, that the distance between the piston rod 3 and the rebound buffer spring 7 in section 7d is smaller than the distance between the inner wall of the cylindrical pipe and the remaining spring regions outside of section 7d.

In this way, it is achieved that the buckling of the rebound buffer spring 7 in the radial direction towards the outside, that is, in the direction of the inner wall of the cylindrical pipe, is avoided reliably. Instead, in the region of section 7d of the example, the helical spring coils having the reduced internal diameter slide on the surface of the piston rod 3, so that the movement of the rebound buffer spring 7 relative to the piston rod 3 in the region of section 7d is guided by the piston rod 3 itself.

Since the piston rod 3 consists of a material of great hardness, there is no chip-removing damage to the surface of the piston rod 3. Chip formation and, accordingly, also the negative consequences of chip formation are avoided reliably in this way. There is also no damage to the rebound buffer spring 7.

It is self-evident that section 7d with the reduced internal diameter of the helical spring coils should be disposed in the region, in which a rebound buffer spring, which is constructed without section 7d, would buckle towards the outside in the event that its buckling load is reached. In the usual case, this will be the region, which is in or near the center between the end regions 7a and 7b of the rebound buffer spring 7.

In the example shown, the end regions 7a, 7b are connected over helical screw coils of constant internal diameter with section 7d. In deviation from the example shown, the internal diameters of the helical screw coils may decrease continuously, starting out from the end regions 7a, 7b, in the direction of section 7d. In this case also, however, it must be ensured that helical spring coils, which have the smallest internal diameter in the whole of the transition region 7c, are provided in section 7d. Furthermore, it is possible that the internal diameters of the helical spring coils decrease, starting from the end regions 7a, 7b, in the direction of section 7d, it being possible for the decrease to be interrupted by one or more sections of coils of constant internal diameter.

This measure has no effect on the bucking behavior of the rebound buffer spring 7 in the transition region 7c. In order to reliably prevent undesirable buckling of the rebound buffer spring 7 radially towards the outside, it is merely necessary to ensure that the internal diameter of the helical spring coils is constructed smaller in section 7d, which is a partial section of the transition region 7c, than the remaining internal diameters of the helical spring coils in the rest of the transition region 7c.

List of Reference Symbols

1. Cylindrical pipe
2. Damper piston
3. Piston rod
4. Annular space
5. Working space
6. Sealing ad guiding unit
7. Rebound buffer spring
7a First end region
7b Second end region
7c Transition region
7d Section

1. Hydraulic vibration damper with a cylindrical pipe (1), which is closed off by a sealing and guiding unit (6) and into which a piston rod (3), carrying a damper piston (2), which is passed through the sealing and guiding unit, can dip in an oscillating manner, the damper piston (2) dividing the interior space of the cylindrical pipe into an annular space (4) on the piston rod side and a working space (5) remote from the piston rod and a rebound buffer spring (7), constructed as a helical spring, which has a first end region (7a), facing the damper piston (2) and a second end region (7b), facing the sealing and guiding unit (6), as well as a transition region (7c) connecting these to end regions, being disposed in the annular space (4) between the damper piston (2) and the sealing and guiding unit (6), characterized in that, within the transition region, the rebound buffer spring (7) has a section (7d), which extends in the axial direction over at least one helical spring coil and in which the internal diameter of the helical spring coils is smaller than the internal diameters of all other helical spring coils in the transition region (7c).

2. The vibration damper of claim 1, characterized and that the section (7d) is disposed in or near the center between the end regions (7a, 7b).

3. The vibration damper of claims 1 in that the internal diameter of the helical spring coils deceases continuously sting from the end regions (7a, 7b) up to the section (7d).

4. The vibration damper of claims 1, characterized in that the distance between the piston rod (3) and the rebound buffer spring (7) in section (7d) is smaller than the distance between the inner wall of the cylindrical pipe (1) and the region of the rebound buffer spring (7) outside of section (7d).
